(19) United States
(12) Patent Application Publication
(10) Pub. No.: US 2003/0031170 A1
(43) Pub. Date: Feb. 13, 2003

(54) Control method and apparatus for a web phone

(76) Inventor: Jyh-Chau Hwang, Taipei Hsien (TW)

Correspondence Address: HARNESS, DICKEY & PIERCE, P.L.C., P.O. BOX 8910, RESTON, VA, 20195, US

(21) Appl. No.: 10/207,031

(22) Filed: Jul. 30, 2002

(30) Foreign Application Priority Data
Aug. 3, 2001 (TW) 090119010

(51) Int. Cl. H04L 12/66

(52) U.S. Cl. 370/352; 379/88.17

(57) ABSTRACT

A control method for a web phone includes: a) determining all possible operating states of the web phone, and transition conditions that control transition from one of the operating states to another of the operating states; b) performing state analysis for the operating states in accordance with the transition conditions to generate a state transition table; c) determining a logical function in canonical sum-of-products form for each bit of an n-bit number that is used to represent the operating states from the state transition table; and d) implementing a finite state machine in accordance with simplified equivalents of the logical functions thus obtained such that the finite state machine can control transition of the web phone from one of the operating states to another of the operating states in accordance with current values of the transition conditions. A control apparatus including the finite state machine is also disclosed.

### CROSS-REFERENCE TO RELATED APPLICATION

This application claims priority of Taiwanese application no. 090119010, filed on Aug. 3, 2001.

### BACKGROUND OF THE INVENTION

1. Field of the Invention

The invention relates to a control method and apparatus for a web phone, more particularly to a control method and apparatus for controlling operation of a web phone with the use of a finite state machine to simplify the control flow of the web phone.

2. Description of the Related Art

Web phones are actually an integration of conventional telephones and network systems. With the use of the web phone, voice data can be transmitted over the Internet for communication with a telephone or computer to result in the benefit of low costs when making international or long-distance calls or for multi-media telephone applications of course, to maintain normal operation of web phones, the operating flow thereof must be well controlled. In the conventional method of web phone control, software is developed according to all possible operating states and control conditions of the web phone. In other words, all operating states and control conditions of the web phone are conceptualized as program statements in an “IF . . . THEN . . . ELSE” manner. As such, when the web phone is operated, coded operations of the software will be executed as a result of inputted conditions. The drawbacks of this approach reside in the difficulty in software debugging and maintenance and in the huge memory requirement. Moreover, the control conditions are dispersed throughout the software and are difficult to trace. Furthermore, when a new operating state of the web phone is to be implemented, the entire software must be overhauled, which is tedious and prone to error.

### SUMMARY OF THE INVENTION

Therefore, the object of the present invention is to provide a control method and apparatus for a web phone that is devoid of the aforesaid drawbacks of the prior art.

According to one aspect of the present invention, there is provided a control method for a web phone that includes the steps of:

a) determining all possible operating states of the web phone, and transition conditions that control transition from one of the operating states to another of the operating states, each of the operating states being represented by an n-bit number, each of the transition conditions having a value of 1 or 0;

b) performing state analysis for the operating states in accordance with the transition conditions so as to generate a state transition table, wherein the state transition table illustrates conversion from a current one of the operating states to a next one of the operating states related to the current one of the operating states based on changes in the transition conditions;

c) from the state transition table obtained in step b), determining a logical function in canonical sum-of-products form for each bit of the n-bit number that is used to represent the operating states, each term in each logical function being expressed as a product of one of the transition conditions and an associated current one of the operating states that would generate the bit corresponding to the logical function so as to result in the n-bit number representing a next one of the operating states; and

d) implementing a finite state machine in accordance with simplified equivalents of the logical functions obtained in step c) such that the finite state machine can control transition of the web phone from one of the operating states to another of the operating states in accordance with current values of the transition conditions.

According to another aspect of the present invention, a control apparatus for a web phone includes:

a finite state machine constructed according to logical functions obtained from a state transition table that illustrates conversion from a current operating state of the web phone to a next operating state of the web phone related to the current operating state based on changes in transition conditions, each of the operating states of the web phone being represented by an n-bit number, each of the transition conditions having a value of 1 or 0, the logical functions being in canonical sum-of-products form and corresponding respectively to the bits of the n-bit number that is used to represent the operating states of the web phone; and

a transition condition register unit connected to the finite state machine for providing the transition conditions thereto.

### BRIEF DESCRIPTION OF THE DRAWINGS

Other features and advantages of the present invention will become apparent in the following detailed description of the preferred embodiment with reference to the accompanying drawings, of which:

FIG. 1 is a transition condition matrix generated in the preferred embodiment of a control method for a web phone according to this invention;

FIGS. 2-1, 2-2 and 2-3 illustrate a state transition table generated in the control method of the preferred embodiment;

FIG. 3 is a state transition diagram of a finite state machine implemented in the control method of the preferred embodiment; and

FIG. 4 is a schematic circuit block diagram of the preferred embodiment of a control apparatus for a web phone according to this invention.

### DETAILED DESCRIPTION OF THE PREFERRED EMBODIMENT

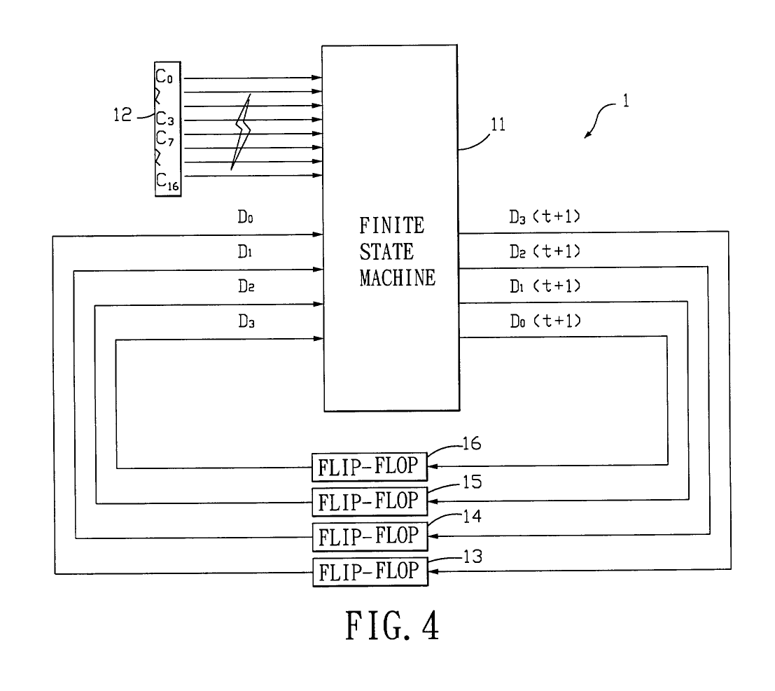

Referring to FIG. 4, according to the preferred embodiment of this invention, a control method for a web phone is implemented in a control apparatus 1 for the web phone. The control apparatus 1 includes a finite state machine 11 and a transition condition register unit 12 electrically connected thereto. The control method includes the steps:

a) First, all possible operating states of the web phone, and transition conditions that control transition from one of the operating states to another of the operating states are determined. Each of the operating states is represented by an n-bit number, and each of the transition conditions has a value of 1 or 0. The web phone in this embodiment includes fifteen operating states S0-S14 as defined in the following TABLE I.

TABLE I

| State | Description |
|---|---|
| S0 | System Off |
| S1 | System Initialization |
| S2 | Line Connected |
| S3 | Line Disconnected |
| S4 | On-Hook |
| S5 | Off-Hook |
| S6 | Ring |
| S7 | Phone Dial-Up |
| S8 | Modem Dial-Up |
| S9 | Audio Path Connected |
| S10 | Data Path Connected |
| S11 | Data Path Disconnected |
| S12 | PPP Authentication |
| S13 | HTTP Packet Request |
| S14 | Display Web Page |

Each of the operating states is represented by a four-bit binary code that includes bits D3, D2, D1, D0. Therefore, S0˜S14 will be coded as 0000˜1110 accordingly and implemented in the finite state machine 11.

The web phone in this embodiment includes seventeen transition conditions C0˜C16 as defined in the following TABLE II.

TABLE II

| Condition | Description |
|---|---|
| C0 | Power Off/On |
| C1 | Line Pull Out/Plug In |
| C2 | Cradle Switch Down/Up |
| C3 | No Ring/Ring Comes In |
| C4 | No Caller ID/Caller ID Comes In |
| C5 | No Busy Tone/Busy Tone Comes In |
| C6 | No VMWI/VMWI Comes In |
| C7 | No CAS Tone/CAS Tone Comes In |
| C8 | Without/Event Triggers Telephone Service |
| C9 | Without/Event Triggers Internet Service |
| C10 | Phone Number Format Incorrect/Phone |
| | Number Format Correct |
| C11 | Modem Connected Fail/Connection |
| C12 | Parallel Set Detected Signal Off/Parallel |
| | Set Detected Signal On |
| C13 | PPP Connection Fail/PPP Authentication |
| | Request From Server |
| C14 | Authentication Rejected By Server/ |
| | Authentication Passed |
| C15 | Authentication Retry/Browsing Stop |
| C16 | No Activity/Packet Received |

Each of the transition conditions is represented by a one-bit number and has a value of 1 or 0. The transition conditions C0˜C16 are temporarily stored in the transition condition register unit 12. Thus, the transition condition register unit 12 is responsible for providing the transition conditions C0˜C16 to the finite state machine 11.

b) A state transition table is generated by performing state analysis for the operating states of the web phone in accordance with the transition conditions.

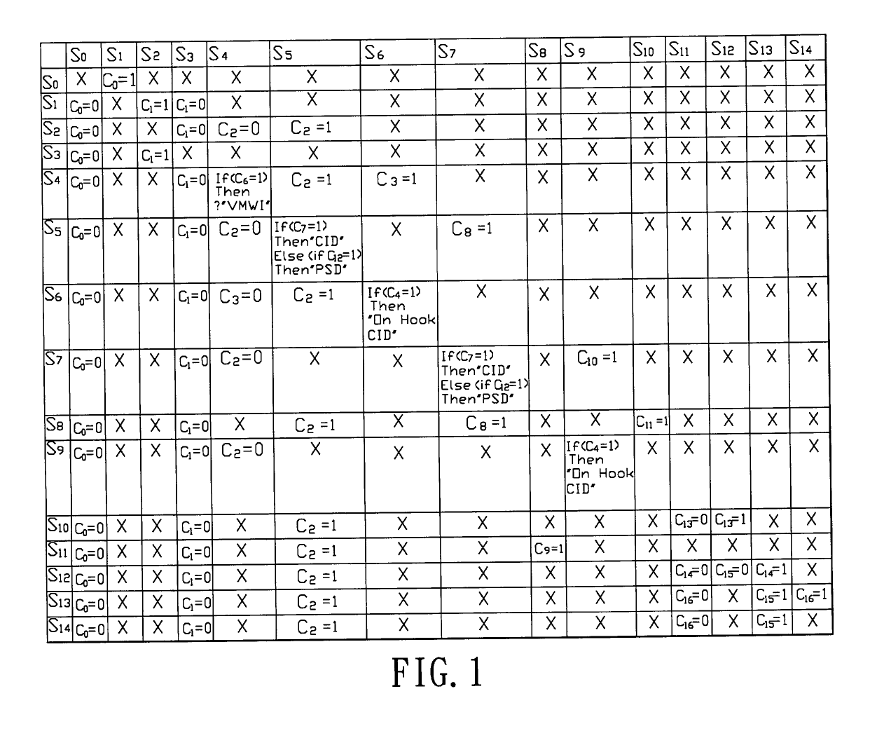

First, a transition condition matrix is generated as shown in FIG. 1, where the rows represent current ones of the operating states, the columns represent next ones of the operating states, and each element in the matrix represents the transition condition that should be satisfied to result in the transition from a corresponding current one of the operating states to a corresponding next one of the operating states. For instance, when a current one of the operating states of the web phone is S2, and an incoming transition condition is determined as C2=1, a transition from the current operating state S2 of the web phone to the next operating state S5 should occur.

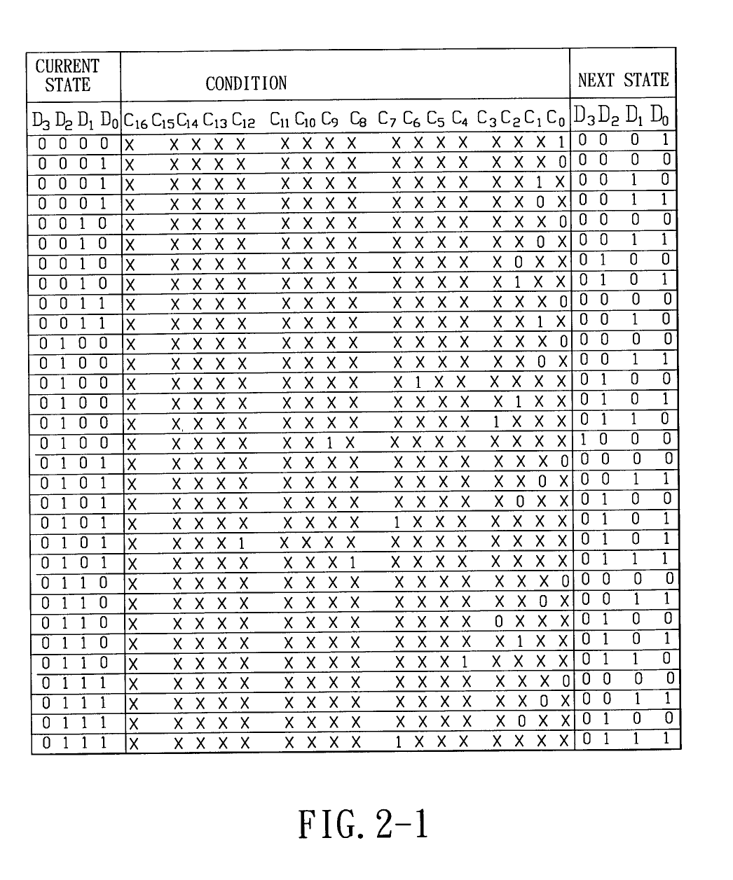

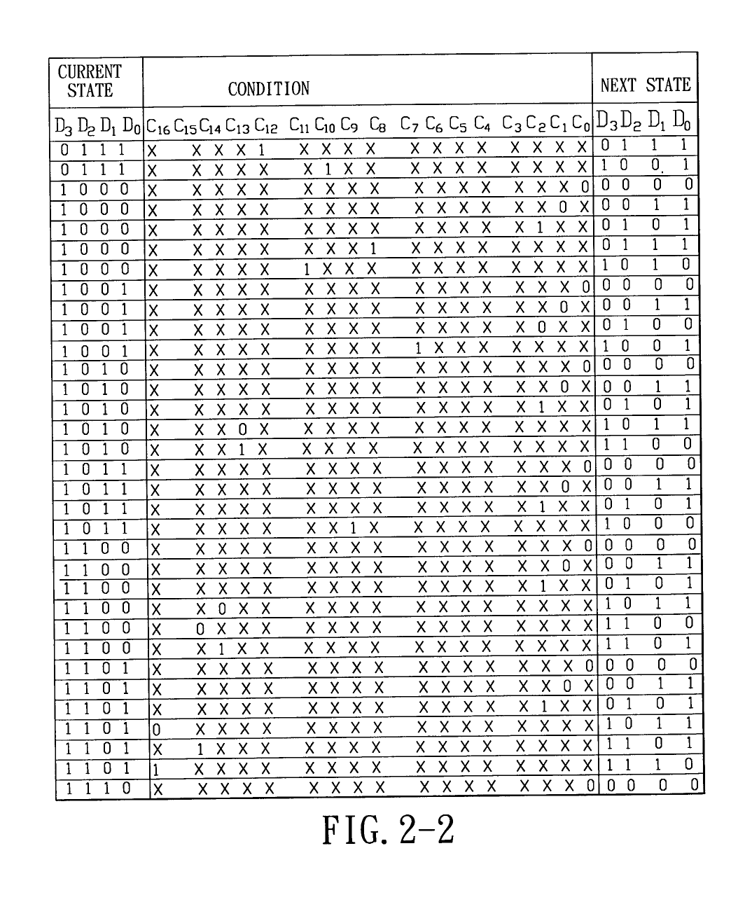

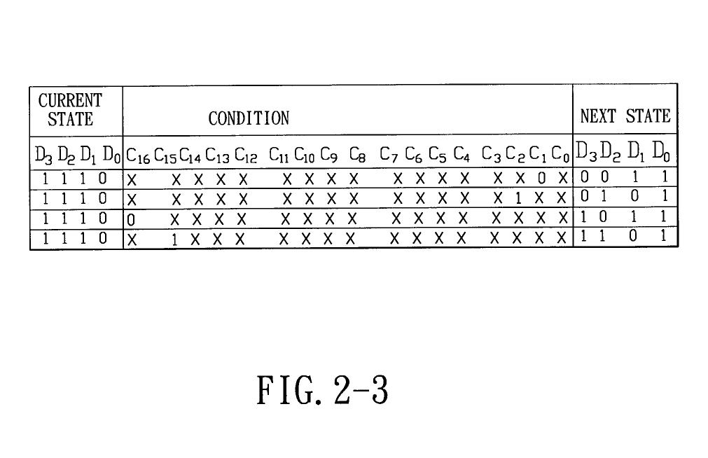

Then, from the transition condition matrix of FIG. 1, a state transition table (see FIGS. 2-1, 2-2, and 2-3) can be generated. Each entry of the state transition table includes a current one of the operating states S0˜S14 (represented by 0000˜1110 in the form of bits D3, D2, D1, D0), a next one of the operating states S0 ˜S14 (represented by 0000˜1110 in the form of bits D3, D2, D1, D0), and a set of the transition conditions C0˜C16 (represented by 0, 1 or X for don't care) that have to be satisfied to result in the transition from the current one of the operating states to the next one of the operating states. In other words, the state transition table illustrates the conversion from a current one of the operating states to a next one of the operating states related to the current one of the operating states based on changes in the transition conditions.

c) From the state transition table obtained in step b), a logical function in canonical sum-of-products form for each bit of the n-bit number that is used to represent the operating states of the web phone is determined. Each term in each logical function is expressed as a product of one of the transition conditions and an associated current one of the operating states that would generate the bit corresponding to the logical function so as to result in the n-bit number representing a next one of the operating states. Simplified equivalents of the logical functions derived from the state transition table of FIGS. 2-1, 2-2 and 2-3 are represented by the following equations:

D3(t+1)=C9+D3′D2D1D0C10+D3D2′D1′D0′C11+D3D2′D1′D0C7+D3D2′D1D0′+D3D2D1D0′C16′+D3D2D1D0′C15 +D3D2D1′

D2(t+1)=D3D2′D1′D0C1′+D3′D2′D1D0′+D3′D2D1+D3C2+D3′D2D0′+D3′D2D0C7+D1′C8+D3′D2D0C12+D3D2′D1D0′C13+D3D2D1′+D3D2D1D0′C15

D1(t+1)=D1′D0+D3′D1+D3′D2D1′C1′+D3D2D1D0′C1′+D3′D2D1′D0′C3+D1′C8+D3D2′D1′D0′C11+D3D2′D1D0′C13′+D3D2D1′D0′C14′+D3D2D1D0′C16′

D0(t+1)=D3′D2′D1′D0′C0+D3′C1′+D3D2′C1′+D3D2D1′C1′+D3D2D1D0′C1′+D3′D2′C2+D0′C2+D3C2+D3′D2D0C7+D3D2′D1′D0C7+D1′C8+D3′D2D1D0C10+D3′D2D0C12+D3D2′D1D0′C13′+D3D2D1′D0′+D3D2C15+D3D2C16′

where D3 (t+1), D2 (t+1), D1 (t+1), D0 (t+1) are the next states of D3, D2, D1, D0 respectively, and the symbol (′) represents a first factorial complement.

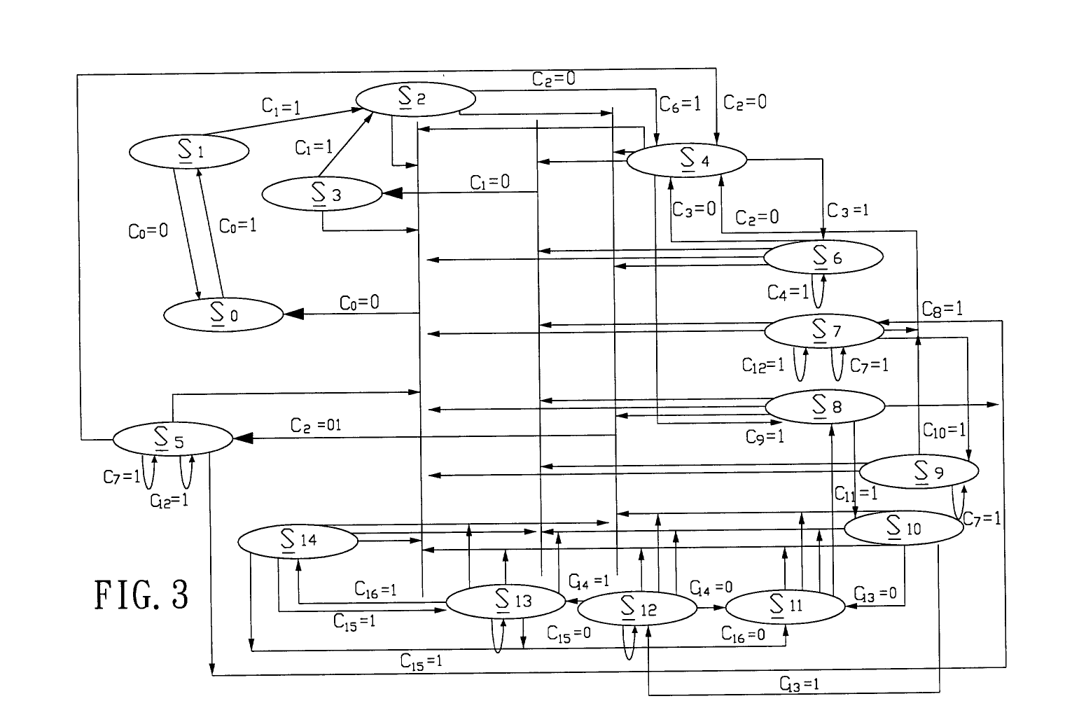

A state transition diagram can also be derived as shown in FIG. 3 from the state transition table of FIGS. 2-1, 2-2 and 2-3 to show state transition flows for each of the operating states.

d) The finite state machine 11 is implemented in accordance with the aforesaid simplified equivalents of the logical functions obtained in step c) such that the finite state machine 11 can control transition of the web phone from one of the operating states to another of the operating states in accordance with current values of the transition conditions provided by the transition condition register unit 12.

Referring again to FIG. 4, the control apparatus 1 further includes four flip-flops 13, 14, 15, 16 that buffer the bits D3 (t+1), D2 (t+1) , D1 (t+1), D0 (t+1) from the finite state machine 11 before providing the same back to the finite state machine 11. Since there are a total of fifteen operating states in this embodiment, [log₂15]=4 flip-flops are needed. When the transition condition register unit 12 provides a transition condition to the finite state machine 11, the finite state machine 11 will deem the bit states stored in the flip-flops 13, 14, 15, 16 as the current state and will proceed to output a next state D3 (t+1)˜D0 (t+1), thereby controlling transition of the web phone from the current operating state to the next operating state. The next state D3 (t+1)˜D0 (t+1) is then stored in the flip-flops 13, 14, 15, 16 to replace the previous state. When another transition condition is provided by the transition condition register unit 12, the aforesaid procedure will be repeated accordingly. Preferably, the finite state machine 11 is loaded into the web phone for controlling the flow of the operating states.

In summary, the control method and apparatus of this invention transforms the conventional procedure-driven approach to a data-driven approach in the control of the operating flow of web phones. The advantages of this invention are apparent. First, the relationships among the operating states and the transition conditions are gathered in the form of tables or matrices, which can be easily checked and updated. Secondly, as in this embodiment, the finite state machine 11 only needs twenty-one bits (four operating state bits plus seventeen transition condition bits) for operation, thereby dramatically lowering the memory requirement. Therefore, the control method and apparatus of this invention can render operation of a web phone system in a more reliable and economical manner. The object of the invention is thus met.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A control method for a web phone, comprising the steps of:
a) determining all possible operating states of the web phone, and transition conditions that control transition from one of the operating states to another of the operating states, each of the operating states being represented by an n-bit number, each of the transition conditions having a value of 1 or 0;
b) performing state analysis for the operating states in accordance with the transition conditions so as to generate a state transition table, wherein the state transition table illustrates conversion from a current one of the operating states to a next one of the operating states related to the current one of the operating states based on changes in the transition conditions;
c) from the state transition table obtained in step b), determining a logical function in canonical sum-of-products form for each bit of the n-bit number that is used to represent the operating states, each term in each logical function being expressed as a product of one of the transition conditions and an associated current one of the operating states that would generate the bit corresponding to the logical function so as to result in the n-bit number representing a next one of the operating states;
d) implementing a finite state machine in accordance with simplified equivalents of the logical functions obtained in step c) such that said finite state machine can control transition of the web phone from one of the operating states to another of the operating states in accordance with current values of the transition conditions.

2. The control method as claimed in claim 1, wherein in step (a), there are at least fifteen operating states defined as:
System Off (S0);
System Initialization (S1);
Line Connected (S2);
Line Disconnected (S3);
On-Hook (S4);
Off-Hook (S5);
Ring (S6);
Phone Dial-Up (S7);
Modem Dial-Up (S8);
Audio Path Connected (S9);
Data Path Connected (S10);
Data Path Disconnected (S11);
PPP Authentication (S12);
HTTP Packet Request (S13); and
Display Web Page (S14);
each of the operating states being represented by a four-bit binary code that includes bits D3, D2, D1 and D0.

3. The control method as claimed in claim 2, wherein in step (a), there are at least seventeen transition conditions defined as:
Power Off/On (C0);
Line Pull Out/Plug In (C1);
Cradle Switch Down/Up (C2);
No Ring/Ring Comes In (C3);
No Caller ID/Caller ID Comes In (C4);
No Busy Tone/Busy Tone Comes In (C5);
No VMWI/VMWI Comes In (C6);
No CAS Tone/CAS Tone Comes In (C7);
Without/Event Triggers Telephone Service (C8);
Without/Event Triggers Internet Service (C9);
Phone Number Format Incorrect/Phone Number Format Correct (C10);
Modem Connected Fail/Connection (C11);
Parallel Set Detected Signal Off/Parallel Set Detected Signal On (C12);
PPP Connection Fail/PPP Authentication Request From Server (C13);
Authentication Rejected By Server/Authentication Passed (C14);
Authentication Retry/Browsing Stop (C15); and
No Activity/Packet Received (C16).

4. The control method as claimed in claim 3, wherein the simplified equivalents of the logical functions are represented by the following equations:
D3(t+1)=C9+D3′D2D1D0C10+D3D2′D1′D0′C11+D3D2′D1′D0C7+D3D2′D1D0′+D3D2D1D0′C16′+D3D2D1D0′C15 +D3D2D1′
D2(t+1)=D3D2′D1′D0C1′+D3′D2′D1D0′+D3′D2D1+D3C2+D3′D2D0′+D3′D2D0C7+D1′C8+D3′D2D0C12+D3D2′D1D0′C13+D3D2D1′+D3D2D1D0′C15
D1(t+1)=D1′D0+D3′D1+D3′D2D1′C1′+D3D2D1D0′C1′+D3′D2D1′D0′C3+D1′C8+D3D2′D1′D0′C11+D3D2′D1D0′C13′+D3D2D1′D0′C14′+D3D2D1D0′C16′
D0(t+1)=D3′D2′D1′D0′C0+D3′C1′+D3D2′C1′+D3D2D1′C1′+D3D2D1D0′C1′+D3′D2′C2+D0′C2+D3C2+D3′D2D0C7+D3D2′D1′D0C7+D1′C8+D3′D2D1D0C10+D3′D2D0C12+D3D2′D1D0′C13′+D3D2D1′D0′+D3D2C15+D3D2C16′
wherein D3 (t+1), D2 (t+1), D1 (t+1), D0 (t+1) are the next states of D3, D2, D1, D0 respectively, and the symbol (′) represents a first factorial complement.

5. A control apparatus for a web phone, comprising:
a finite state machine constructed according to logical functions obtained from a state transition table that illustrates conversion from a current operating state of the web phone to a next operating state of the web phone related to the current operating state based on changes in transition conditions, each of the operating states of the web phone being represented by an n-bit number, each of the transition conditions having a value of 1 or 0, the logical functions being in canonical sum-of-products form and corresponding respectively to the bits of the n-bit number that is used to represent the operating states of the web phone; and
a transition condition register unit connected to said finite state machine for providing the transition conditions thereto.

6. The control apparatus as claimed in claim 5, wherein the web phone has at least fifteen operating states defined as:
System Off (S0);
System Initialization (S1);
Line Connected (S2);
Line Disconnected (S3);
On-Hook (S4);
Off-Hook (S5);
Ring (S6);
Phone Dial-Up (S7);
Modem Dial-Up (S8);
Audio Path Connected (S9);
Data Path Connected (S10);
Data Path Disconnected (S11);
PPP Authentication (S12);
HTTP Packet Request (S13); and
Display Web Page (S14);
each of the operating states being represented by a four-bit binary code that includes bits D3, D2, D1, D0.

7. The control apparatus as claimed in claim 6, wherein there are at least seventeen transition conditions defined as:
Power Off/On (C0);
Line Pull Out/Plug In (C1);
Cradle Switch Down/Up (C2);
No Ring/Ring Comes In (C3);
No Caller ID/Caller ID Comes In (C4);
No Busy Tone/Busy Tone Comes In (C5);
No VMWI/VMWI Comes In (C6);
No CAS Tone/CAS Tone Comes In (C7);
Without/Event Triggers Telephone Service (C8);
Without/Event Triggers Internet Service (C9);
Phone Number Format Incorrect/Phone Number Format Correct (C10);
Modem Connected Fail/Connection (C11);
Parallel Set Detected Signal Off/Parallel Set Detected Signal On (C12);
PPP Connection Fail/PPP Authentication Request From Server (C13);
Authentication Rejected By Server/Authentication Passed (C14);
Authentication Retry/Browsing Stop (C15); and
No Activity/Packet Received (C16).

8. The control apparatus as claimed in claim 7, wherein the logical functions are represented by the following equations:
D3(t+1)=C9+D3′D2D1D0C10+D3D2′D1′D0′C11+D3D2′D1′D0C7+D3D2′D1D0′+D3D2D1D0′C16′+D3D2D1D0′C15 +D3D2D1′
D2(t+1)=D3D2′D1′D0C1′+D3′D2′D1D0′+D3′D2D1+D3C2+D3′D2D0′+D3′D2D0C7+D1′C8+D3′D2D0C12+D3D2′D1D0′C13+D3D2D1′+D3D2D1D0′C15
D1(t+1)=D1′D0+D3′D1+D3′D2D1′C1′+D3D2D1D0′C1′+D3′D2D1′D0′C3+D1′C8+D3D2′D1′D0′C11+D3D2′D1D0′C13′+D3D2D1′D0′C14′+D3D2D1D0′C16′
D0(t+1)=D3′D2′D1′D0′C0+D3′C1′+D3D2′C1′+D3D2D1′C1′+D3D2D1D0′C1′+D3′D2′C2+D0′C2+D3C2+D3′D2D0C7+D3D2′D1′D0C7+D1′C8+D3′D2D1D0C10+D3′D2D0C12+D3D2′D1D0′C13′+D3D2D1′D0′+D3D2C15+D3D2C16′
where D3 (t+1), D2 (t+1), D1 (t+1), D0 (t+1) are the next states of D3, D2, D1, D0 respectively, and the symbol (′) represents a first factorial complement.
